(19) United States
(12) Patent Application Publication
(10) Pub. No.: US 2014/0267718 A1
(43) Pub. Date: Sep. 18, 2014

(54) System And Method For Monitoring A Patient

(71) Applicant: All Systems Designed Solutions, Inc., Kansas City, KS (US)

(72) Inventors: Kourtney Govro, Peculiar, MO (US); Gary Venable, JR., Kansas City, MO (US)

(21) Appl. No.: 14/213,804

(22) Filed: Mar. 14, 2014

Related U.S. Application Data
(60) Provisional application No. 61/786,033, filed on Mar. 14, 2013.

(51) Int. Cl. G06Q 50/22; G06Q 10/10

(52) U.S. Cl. CPC G06Q 50/22; G06Q 10/10
USPC 348/143

(57) ABSTRACT

Systems and methods are provided for monitoring the position of a body on a bed with the goal of mitigating falls, and in the case that the body has already fallen to the ground, minimizing the time the body is on the ground. These systems and methods use camera analytics to monitor the movement of the patient, and, in combination with clinical analytics, to determine if the body is in danger of falling out of the bed or if the body has fallen out of the bed. If either of these events occur, the systems and methods send an alarm which may be associated with a live video feed of the bed.

### CROSS-REFERENCE TO RELATED APPLICATIONS

This application claims the benefit of U.S. Provisional Patent Application No. 61/786,033 filed Mar. 14, 2013, the disclosure of which is incorporated herein by reference.

### BACKGROUND

1. Field of the Invention

This disclosure relates to a patient monitoring system, and more specifically to using video analytics and clinical analytics to mitigate the risk of patient falls.

2. Description of the Related Art

Monitoring patients is an important aspect of patient care. Healthcare facilities monitor various vital signs such as respiratory rate and heart rate.

Patient falls are a commonly-occurring adverse event that are routinely reported by healthcare facilities. Patient falls can result in fear of falling again, broken bones, increased chance of illness, and even death. If a patient falls and remains undetected, the patient could remain on the ground for hours, through the night, or until the next time they are checked.

Bed rails long been used to keep patients in the bed, as well as physical restraints. Some systems include detectors which enable staff to know whether the rails are in up or down positions.

Bed exit alarm systems have been known for some time. These systems may use pressure sensors or other means to detect that a patient is not longer in the bed. See, e.g., Olson (U.S. Pat. No. 6,847,301) and Gentry (U.S. Pat. No. 7,656,299). These sensors alone do not prevent falls, have been used in fall-detection programs.

### SUMMARY

The following presents a simplified summary of the invention in order to provide a basic understanding of some aspects of what is disclosed herein. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

The disclosed embodiments include a system and a method for monitoring a patient. The system uses a digital camera included in a network. Also, there is a video component which receives video information from an IP camera and determines patient position relative to an elevated patient supporting device (e.g., bed).

The system also includes a clinical component. The clinical component receives clinical information regarding the patient resting on the bed for example, from a: (i) telemetry device, (ii) bed alarm sensor, (iii) nurse call system, or (iv) bed rail position detector.

An integrating component in the system analyzes the video and clinical information, and sending an alert if a combined analysis indicates an actual or potential fall.

The methods herein are computer-implemented. They involve continually checking a patient for movement using the IP video camera. If an electronic indication of movement is received, a position of a patient relative to an elevated patient supporting device (e.g., bed) is determined using the camera and associated analytics. Clinical information regarding the patient is also factored in to determine whether the clinical information is consistent with a fall, and what is being visualized by the video equipment. Where warranted, the system delivers an alarm over a network (e.g., wirelessly) to a health care provider if an integration of the video information along with the clinical information suggests a fall.

In embodiments, a basic locating process is used where patient position is analyzed relative to observed zones, and an alarm is transmitted if a patient is seen breaking a plane of the zone in a direction away from the patient supporting device. Embodiments also use a discernment process for eliminating movements into a plane from locations outside the patient supporting device as being indicative of the acts of a person other than a patient.

Alternatively, an advanced analytics process can be used which documents patient movements related to falls over time, maintains a record of these movements, and uses the movements for predictive modeling purposes. The advanced analytics process also includes, in embodiments, a false-alarm reduction process. This process utilizes the documented patient movements related to falls over time for the purpose of narrowing the number of activities which would trigger an alarm.

Telemetry information is also considered. More specifically, whether a biological property is consistent with video information received of a possible fall will be considered along with the video information to assess a possible fall by the patient. Whether or not there has been a patient initiated nurse call, and whether a bed exit alarm has been activated are also considered according to the disclosed processes.

In some embodiments, the alert is coupled with a live video feed from the area of the bed.

### BRIEF DESCRIPTION OF THE DRAWINGS

FIG. 1 illustrates a system diagram for an environment in which one embodiment of the disclosed processes could be performed.

FIG. 2 illustrates a process flow diagram for one embodiment of the processes of the fall mitigating tool of the present invention.

FIG. 3 shows an overhead view of a bed arrangement where zones have been created for the purpose of detecting a potential fall situation.

### DETAILED DESCRIPTION

The disclosed systems and methods mitigate the risk of patient falls using video analytics as well as clinical analytics (including bed exit alarms) to alert healthcare professionals that a patient has fallen, lessening the time the patient is on the floor.

Unless otherwise specified, any terms used herein should be interpreted broadly and liberally to the extent allowed by the art and the meaning of the words offered in context.

FIG. 1 shows a schematic overview of a system 100 for mitigating falls or decreasing the amount of time a fallen patient is on the floor according to an embodiment of the current invention. In broad terms, the system 100 is included in a network 110. The components used, in embodiments, include an IP camera 130 which is associated with a video analytics data input device 120. Device 130 may be included in the camera system 130 itself, or be a separate component.

Also included in the disclosed embodiment for system 100 is a clinical analytics input device 140. Clinical analytics input device 140 is in communications with a bed alarm sensor 150, a nurse call system 160 (e.g. patient activated button), a telemetry device 170 (e.g., which monitors heart rate and other patient biological parameters), and a bed rail position detector 180.

An application running on the hospital computing system 190 is used to receive and then process both clinical as well as video information detected regarding a patient, then transmit alerts staff or other interested personnel. By integrating the clinical analytics with the video analytics, falls can be addressed quicker, and with more accuracy than with conventional arrangements.

The clinical information, in some embodiments, is pre-processed by the clinical analytics input device 140. Clinical analytic devices like device 140 receive signals and/or data from the gathering devices (bed alarm 150, nurse call system 160, telemetry device 170, and rail detector 180).

Useful video information regarding the patient will also be received from IP camera 130, processed by the video analytics device, and then received over the network by the hospital computing system 190.

Integration software running on the hospital computing system 190 ties information from both the clinical and video gathering devices, analyzes it, and then initiates actions (e.g., alerts/alarms if necessary).

The initiation of an alarm, e.g., upon the identification of an emergency situation regarding the patient based on video as well as clinical information received, will be qualified according to an automated decision process discussed hereinafter. When an emergency is detected (e.g., the patient has fallen out of bed), the integrating application hospital computing system 190 will transmit alarms to one or more output devices 195. Output device 195 could be a primary caregiver's wireless device, a printer, a monitor, centralized alarm boxes, centralized command post, or the hospital's general alarm system. For example, in embodiments, the device 195 could be the smartphone of the health care provider responsible for monitoring the patient (doctor or nurse).

The processes used to alert staff are shown in FIGS. 2-3. The flow diagram 200 in FIG. 2 shows, at a high level, shows an embodiment for some processes executed by the integrating computer application running on the hospital computing system 190. It should be understood that, although a specific logic tree has been presented in FIG. 2, it is entirely possible that numerous other steps, different ordering, and reductions of steps could be presented and still fall within the scope of the invention.

The process in flow diagram 200 starts at a step 202. The process then moves on to a step 204, where a determination is made as to whether movement exists. This is determined by the camera equipment (camera 130 and related analytics component 120).

Whether movement exists or not in step 204 will change the handling of the situation. If movement exists, the process will move on to both steps 206 and 212. Step 206 queries whether the rails on the bed are up or not is assessed by system 140 based on readings received form the rail detector 180. If a “rails down” signal is received from detector 180, fall concerns are more valid, and the process moves on to a step 208 where the patient's location is evaluated. If a “rails up” situation is detected, the patient is less likely to fall out of the bed, and thus, the process will instead move on to a step 212 where the clinical analytics device 140 determines whether or not the patient has activated the nurse call button 160.

The determination in step 208 as to whether a patient location problem exists is made using additional information received form the video equipment (devices 120 and 130). Further, this step might involve the employment of either (i) a basic zone-based analytical processes, or (ii) a more advanced camera analytics arrangement.

Basic analytics. In one embodiment, basic analytics are executed by a smart camera system to determine patient position that is indicative of an alert-worthy situation. In this, the basic embodiment, the analytics device 120 (which could be housed in our outside of IP camera 130) is configured to determine patient location problems. More specifically, in embodiments, the processes use box rules to establish planes which, when broken, indicated movement.

FIG. 3 shows a representation of how different zones can be evaluated to enable the evaluation of patient location as indicative of a dangerous event, e.g., where the patient has fallen out of bed. Referring to the figure, an elevated patient resting area 300 (e.g., a bed) is shown from a top view.

Presuming the existence of a patient in bed 300, concerns often exist with respect a patient falling from its elevated position. For example, the patient may be injured by impact with the ground. Also, a patient making an ill-advised attempt to get out of the bed may, upon falling, become disconnected from critical health-sustaining equipment. Further, the fall may indicate an urgent need to get to a bathroom. Regardless, the IP camera 130 in conjunction with the video analytics device together establish recognizable zones—in this embodiment—multiple zones 302a, 302b, and 304a and 304b. Movement by the patient into either of proximate lateral zones 302a and 302b would indicate a patient at the edge of the bed, and thus present a first, moderate level of alarm. A visually-detected location in into the more distal lateral zones 304a and 304b would be indicative of the patient having fallen out of bed which would justify a second, more heightened level of alarm. Those skilled in the art will recognize that numerous different zone arrangements could exist and still fall within the scope of this invention. Thus, the particular zone configurations shown in FIG. 3 are only one example of many that could be used.

Patient-position analysis step 208 may include a process where movement detected into the plane is eliminated from consideration, and will not elevate alarm status. Movements out of the plane, if not associated with a corresponding recent movement into the plane, will be evaluated for relevance based on zone position, movements, directional considerations, and timing. These processes enable the discernment of movements into and out of the planes so that, e.g., nurses tending to a patient in a zone monitored will not sound a false alarm.

Advanced Analytics. An alternative embodiment involves the use of more advanced analytics on the video analytics component 120. Using this sort of system, movements by a patient can be documented over time, maintained, and used for predictive modeling purposes. For example, rather than the boxed plane concept discussed in the last section, the one could use the camera logic to record the actual patient movements that immediately preceded earlier falls, and then upon a later identification of similar movements, generate an alarm earlier, and in some instances even predict a fall before it occurs. This would result in the alarm being transmitted more swiftly.

Another advantage of the advanced analytics embodiment is that the types of conditions in which an alarm would be generated can be narrowed significantly. By recording past fall and non-fall movements, consistent patterns will be recognized, which, when used for predictive modeling, can reduce false alarms.

The incorporation of steps 212, 214, and 216 into FIG. 2 show how the conventional alarm systems (e.g., bed alarm 150, nurse call 160, telemetry equipment 170) can be incorporated along with the video analytics discussed above to better mitigate patient falls. Even if no movement is detected in step 204, the process will queries whether there has been a nurse call activation in step 212 (e.g., where the patient has hit the nurse call button).

If a nurse call has been made (using equipment 160), the process moves on to step 214 where it will be determined whether telemetry equipment 170 indicates biological abnormalities in the patient (e.g., an elevated heart rate) which would increase the likelihood that an actual fall has occurred. If this is the case, the process moves on to the already discussed patient position step 208 for basic or advanced analytics of what is being seen in video, and for a determination as to whether what is being seen is indicative of a fall. If, in step 214, telemetry equipment 170 readings (e.g. biological readings from the patient) do not indicate a fall, the process ends in a step 218. Although step 218 indicates an end to the overall process 200, it should be recognized to those in the art that the process continually repeats itself (beginning with step 202) so that the patient can be continually monitored.

If a nurse call has not been activated in step 212, the process moves on to a step 216 for a determination as to whether bed exit alarm 150 has been activated. If the nurse call has been activated in step 212, then the process moves on to the patient position analysis step 208.

Again, if the patient position analysis determines a fall has occurred in step 208, an alert will be made to staff in a step 210 using some sort of an output device 195 (see FIG. 1).

If a bed exit alarm has been activated in step 216, rather than going straight to alert mode, the process first considers the analysis conducted in each of telemetry step 214 and then position analysis step 208. Assuming both of those steps warrant an alarm, an alert will be made in step 210. It is alternatively possible, of course, that the video and clinical information will not support a fall has occurred. In this situation, the process will be directed to end at step 218. Thus, the bed exit alarm can be shunted if determined to be inaccurate by the video and clinical information. In some circumstances, the output device 210 could be, e.g., a standard user interface on a personal computer, and the alert would not only indicate the alarm, but also enable the user to view a live video feed from the IP camera 130 to make an assessment. Alternatively, the output device could be a wireless handheld device (e.g., smartphone) which could also support a live video feed. Any combination of these, or other devices could be used as the output devices to accomplish alerts in the fashion discussed above.

The above described methods (processes), including portions thereof, can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the disclosed subject matter, the preceding description is intended to be exemplary only. It should not be used to limit the scope of the disclosure, which should be determined by reference to the following claims.

Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will also be understood that certain features and subcombinations are of utility and may be employed without reference to other features and subcombinations and are contemplated within the scope of the claims. Not all steps listed in the various figures need be carried out in the specific order described.

1. A computer-implemented method for monitoring a patient, the method comprising:
continually checking for patient movement using a video camera system;
if an electronic indication of movement is received, determining a position of a patient relative to an elevated patient supporting device using a networked video device;
electronically receiving clinical information regarding the patient to determine whether the clinical information is consistent with a fall; and
delivering an alarm over a network to a health care provider if an integration of the video information with the clinical information suggests a fall.

2. The method of claim 1 comprising:
A locating process for analyzing a position of a patient relative to observed zones, and executing said alarm delivery step if a patient is seen breaking a plane of the zone in a direction away from the patient supporting device.

3. The method of claim 2 comprising:
A discernment process for eliminating movements into a plane from locations outside the patient supporting device as being indicative of the acts of a person other than a patient.

4. The method of claim 1 comprising:
An advanced analytics process which documents patient movements related to falls over time, maintains a record of these movements, and uses the movements for predictive modeling purposes.

5. The method of claim 4 comprising:
a false-alarm reduction process which utilizes the documented patient movements related to falls over time for the purpose of narrowing the number of activities which would trigger an alarm.

6. The method of claim 1 comprising:
a process for disregarding patient movement if the rails on the elevated patient supporting device are up.

7. The method of claim 1 comprising:
a telemetry considering process for determining whether a biological property is consistent with video information received of a possible fall.

8. The method of claim 7 comprising:
a nurse call monitoring process which, upon an activation of a nurse call by a patient, results in the telemetry considering process.

9. The method of claim 1 wherein the clinical information includes an indication of whether a bed exit alarm has been activated, and if so, considers the clinical information, evaluates the video information, and dispatches an alert if warranted.

10. The method of claim 1 comprising:
Transmitting live video from the camera of the area of the patient supporting device along with the alert.

11. A system for monitoring a patient comprising:
a digital camera included in a network;
a video component, the component receiving video information from the digital camera and determining a position of a patient relative to an elevated patient supporting device;
a clinical component, the clinical component receiving clinical information regarding a patient resting on the patient supporting device, the clinical information being derived from one of: (i) a telemetry device, (ii) a bed alarm sensor, (iii) a nurse call system, and (iv) a bed rail position detector;
an integrating component, said integrating component receiving the video and clinical information and sending an alert if a combined analysis of the video information and clinical information is indicative of an actual or potential fall.

12. The system of claim 11 wherein the elevated patient supporting device is a bed in a hospital.

13. The system of claim 11 wherein the alert is receivable on a wireless device possessed by a health care provider.

14. The system of claim 13 wherein the alert also enables the receiving party to access a live video of the area of the bed.
